(19) United States
(12) Patent Application Publication
(10) Pub. No.: US 2013/0089300 A1
(43) Pub. Date: Apr. 11, 2013

(54) Method and Apparatus for Providing Voice Metadata

(71) Applicants: Aravind Soundararajan, Chennai (IN); Shailesh Ramamurthy, New Bombay (IN)

(72) Inventors: Aravind Soundararajan, Chennai (IN); Shailesh Ramamurthy, New Bombay (IN)

(73) Assignee: General Instrument Corporation, Horsham, PA (US)

(21) Appl. No.: 13/253,353

(22) Filed: Oct. 5, 2011

(51) Int. Cl. H04N 9/80

(52) U.S. Cl. 386/241; 386/243; 386/E09.011

(57) ABSTRACT

A method and apparatus associates voice metadata with a content item such as a recorded program using a content guide. In one embodiment, a process presents the content guide to a viewer. The viewer makes a first request to select a content item listed in the content guide, and this first request is received by the processor. In response to the first request, the processor presents content information for the selected content item. The content information may include one or more voice metadata options for the selected content item. The method and apparatus may be implemented in a digital video recorder (DVR). A DVR content searching method is also disclosed. In one embodiment, search parameters are received at the DVR, and the DVR searches through an index of voice metadata associated with one or more content items stored at the DVR.

### BACKGROUND

Currently, information stored in a digital video recorder (DVR) content listing for a recorded program is typically the information that is associated with that same program in an electronic program guide (EPG) provided by the content or service provider. This standardized text information, while helpful in providing identifying information about the program, does not allow for any personalization.

Therefore there is an opportunity to provide personalization of content information stored in a DVR.

### BRIEF DESCRIPTION OF THE DRAWINGS

So that the manner in which the above recited features of the present invention are attained and can be understood in detail, a more particular description of the invention may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system 100 for streaming or broadcasting media content;

FIG. 2 illustrates an exemplary electronic program guide (EPG) provided by a content provider;

FIG. 3 illustrates an exemplary content listing provided by a DVR;

FIG. 4 illustrates an exemplary program information screen 400 showing program or content information of a selected program or content item;

FIG. 5 illustrates an exemplary screen 500 for use in adding voice metadata;

FIG. 6 illustrates an exemplary screen 600 for use in recording voice metadata;

FIG. 7 illustrates an exemplary screen 700 for use in adding pre-recorded voice metadata;

FIG. 8 illustrates an exemplary screen 800 showing a listing of pre-recorded voice metadata;

FIG. 9 illustrates an exemplary program information screen 900 showing program or content information of a selected program or content item;

FIG. 10 illustrates an options screen 1000 for editing voice metadata associated with program or content information, according to one embodiment;

FIG. 11 illustrates an exemplary index file structure 1100;

FIG. 12 illustrates a diagram 1200 describing voice tag use cases;

FIG. 13 illustrates a diagram 1300 describing voice tag use cases;

FIG. 14 illustrates a diagram 1400 describing voice tag use cases;

FIG. 15 illustrates a method 1500 for associating voice metadata with a program or content item using a content guide, according to one embodiment;

FIG. 16 illustrates a method 1600 for adding voice metadata, according to one embodiment;

FIG. 17 illustrates a method 1700 for editing voice metadata associated with a program or content item, according to one embodiment;

FIG. 18 illustrates a method 1800 for deleting voice metadata associated with a program or content item, according to one embodiment;

FIG. 19 illustrates a method 1900 for rendering voice metadata associated with a program or content item, according to one embodiment;

FIG. 20 illustrates an DVR content searching method 2000, according to one embodiment; and

FIG. 21 illustrates a block diagram of an example device 2100, according to one embodiment.

### DETAILED DESCRIPTION

A method tags and associates voice metadata with a content file, stored program, or other stored content in a DVR. In one embodiment, the content guide is presented. A first request to select a content item, e.g., stored program, listed in the content guide is received. Content information (e.g., copied from the EPG for a selected content item) is presented in response to the first request. The content information may include one or more voice metadata options for the selected content item.

In one embodiment, the one or more voice metadata options may be a request to add voice metadata. The added voice metadata may be associated with the selected content item. Voice metadata may be added by prompting the user to record a spoken utterance. Voice metadata may be added by retrieving pre-recorded voice metadata.

When multiple user profiles are enabled, the added voice metadata may be associated with a user profile. The added voice metadata may be associated with the user profile using biometric information of a user. The added voice metadata may be associated with the user profile in response to a selection by a user.

In one embodiment, the one or more voice metadata options is a request to edit existing voice metadata. Existing voice metadata may be edited by re-recording the voice metadata. Existing voice metadata may be edited by adding additional voice metadata.

In one embodiment, the one or more voice metadata options is a request to delete existing voice metadata. In one embodiment, deleting existing voice metadata is allowed only by a system administrator or an authenticated user who added the voice metadata.

In one embodiment, the content guide includes information from an EPG provided by a content provider via a set top box (STB). In one embodiment, the content guide includes a content listing of local content saved on a digital video recorder by one or more users.

In one embodiment, the one or more voice metadata options is a request to play voice metadata associated with the selected content item. In this embodiment, the voice metadata is rendered. The voice metadata may be rendered automatically upon the presentation of the content information or may be rendered in response to a specific request initiated by the user.

An apparatus associates voice metadata with a content item stored in a DVR. In one embodiment, the apparatus includes a processor for presenting a content guide. The apparatus also includes a receiver for receiving a first request to select a content item listed in the content guide. The processor presents content information for the selected content item in response to the first request. The content information may include one or more voice metadata options for the selected content item.

A content guide searching method is disclosed. In one embodiment, search parameters are received at a DVR. An index of voice metadata associated with one or more content items listed in the content guide is searched. The search parameters may be voice-based. The voice-based search parameters may include a spoken utterance. In one embodiment, the indexed voice metadata is converted to an abstract representation in order to recognize a subsequent spoken utterance of voice metadata. The search may result in a voice tag and one or more associated content items.

This method or apparatus may be used to add, edit, delete, and/or render voice metadata to program information from an EPG of a STB or to content information from a content index of a DVR. Using this method or apparatus, users can personalize content files by recording audio commentary for their own use or use by others in the household.

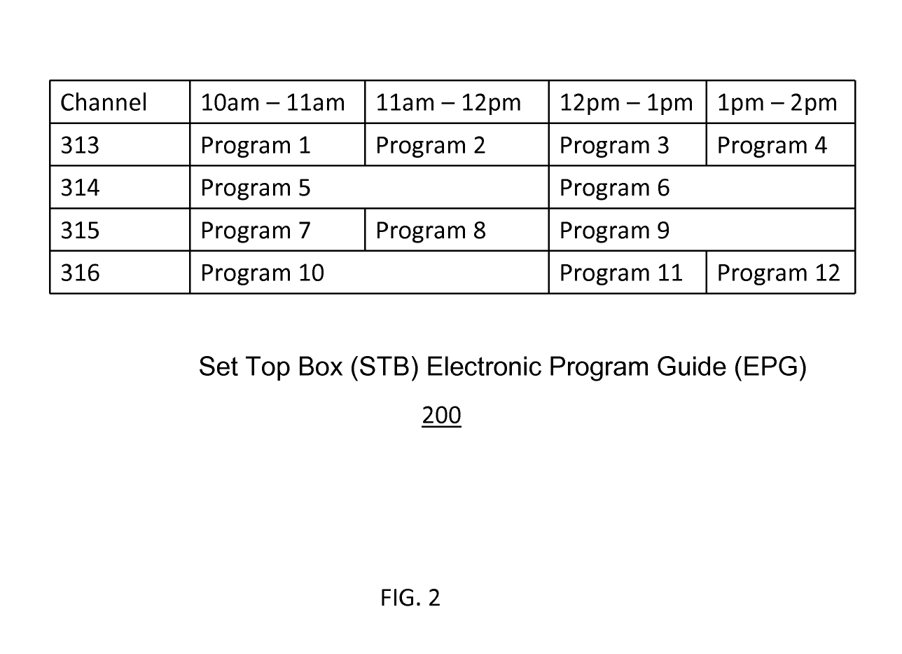

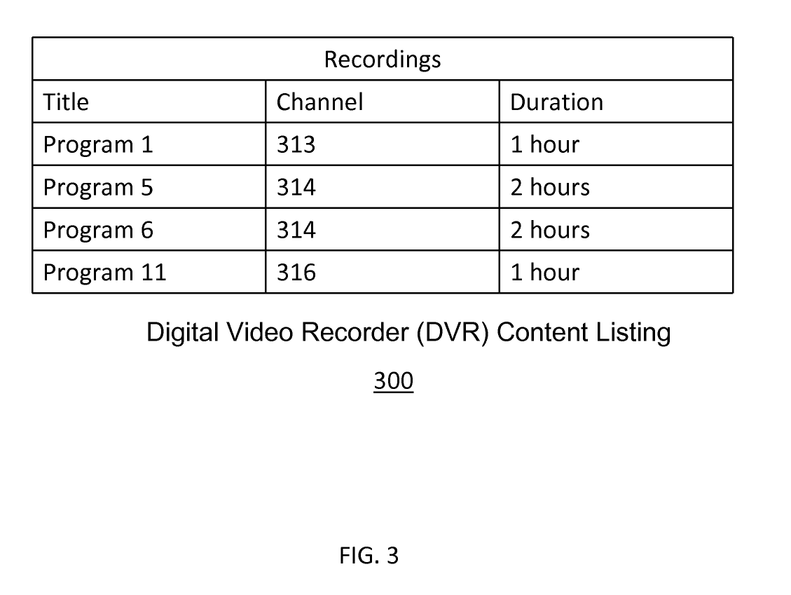

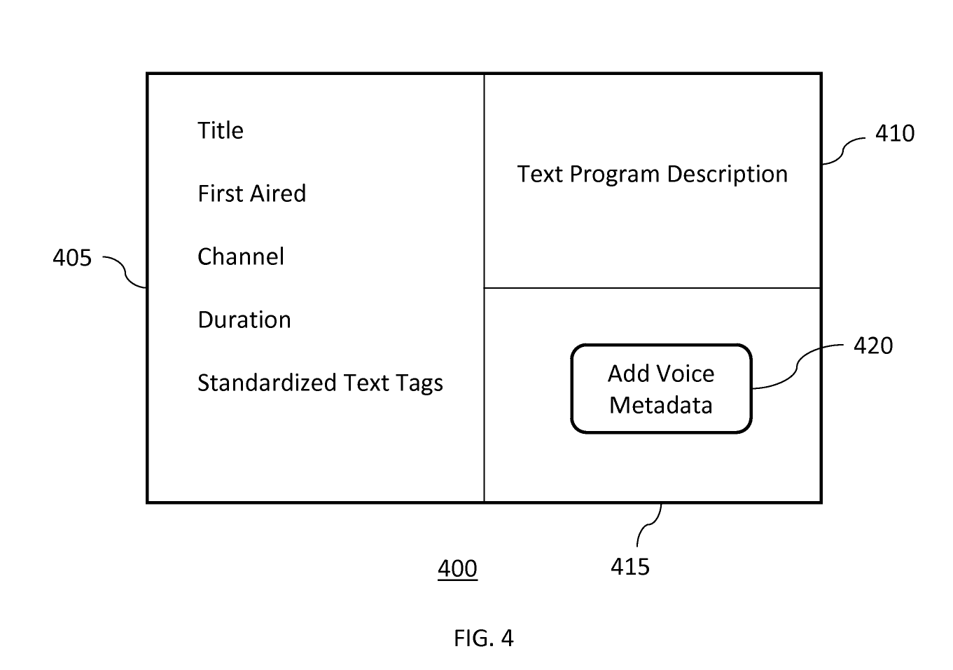

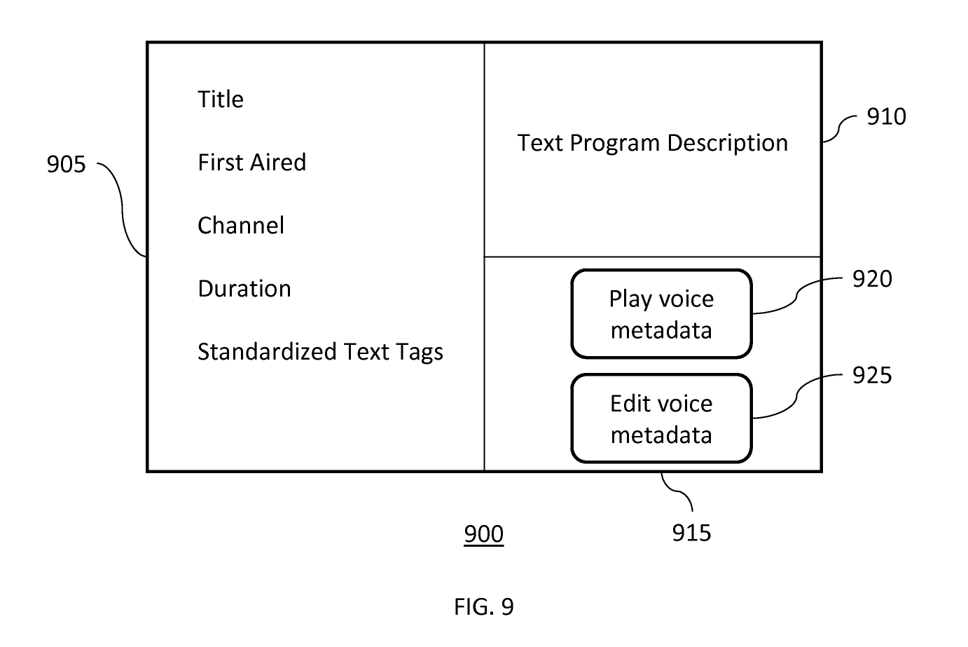

An EPG is information provided by the content or service provider to a STB regarding scheduling and content (channel, time, title, episode, genre color-code, etc.) of a program. The EPG may have a higher “program schedule” layer (FIG. 2) and a more detailed “program information” layer (FIG. 4 or FIG. 9) with additional plot synopsis, image, and first-aired information. A content listing is a listing of recorded content items stored by a DVR. Each content item detailed in the content listing may have associated content information. This content information may be information copied from the EPG and may be optionally augmented by voice tags for the recorded content items (e.g., programs) stored by the DVR. Like a STB's EPG, the DVR's content listing may have a higher “content index listing” layer (FIG. 3) and a more detailed “content information” layer (FIG. 4 or FIG. 9). The terms “EPG”, “program information”, and “program” are used in relation to a STB. The terms “content listing”, “content information”, and “content item” are used in relation to a DVR. The EPG and DVR content index may be generically referred to as a Content guide. For the purposes of this disclosure, the terms “recorded program information” and “content information” are interchangeable. Likewise, “content” may be referred to as a “recorded program” (broadcast content currently being recorded) or a “content item” (fully recorded content).

The present disclosure specifies two abstracted “layers” of metadata presentation (e.g., index and information) as well as the actual content. The first layer, a content guide (e.g., EPG or content listing) provides a list of programs/content. The second layer, a program information or content information layer, provides additional information about the selected content. The second layer supports storage of a pointer to a voice metadata file.

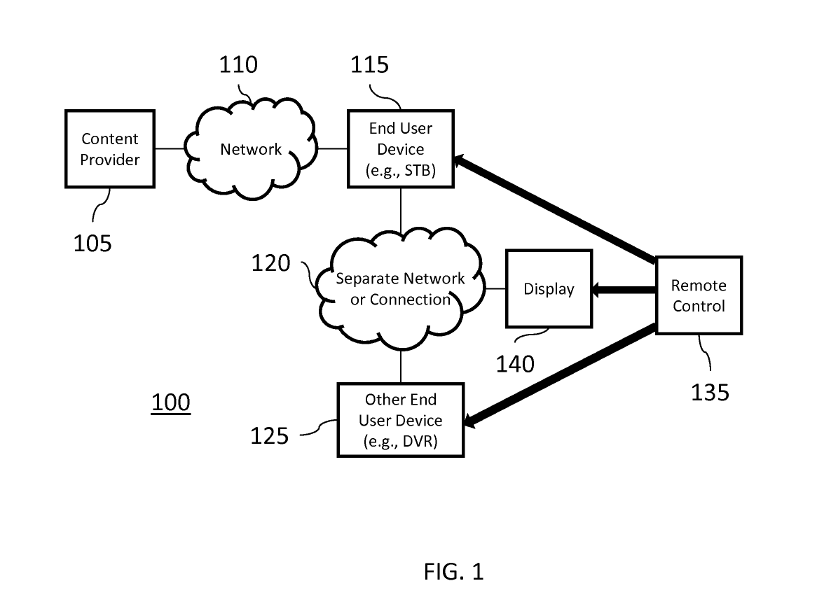

FIG. 1 illustrates an exemplary system 100 for streaming or broadcasting media content. Content provider 105 streams media content via network 110 to an end-user device 115. Content provider 105 may be a headend, e.g., of a satellite television system or Multiple System Operator (MSO), or a server, e.g., a media server or Video on Demand (VOD) server. Network 110 may be an internet protocol (IP) based network. Network 110 may also be a broadcast network used to broadcast television content where content provider 105 is a cable or satellite television provider. In addition, network 110 may be a wired network, e.g., fiber optic, coaxial, or wireless access network, e.g., 3G, 4G, Worldwide Interoperability for Microwave Access (WiMAX), High Speed Packet Access (HSPA), HSPA+, Long Term Evolution (LTE). End user device 115 may be a set top box (STB), personal digital assistant (PDA), digital video recorder (DVR), computer, or mobile device, e.g., a laptop, netbook, tablet, portable media player, or wireless phone. In one embodiment, end user device 115 functions as both a STB and a DVR. In addition, end user device 115 may communicate with other end user devices 125 via a separate wired or wireless connection or network 120 via various protocols, e.g., Bluetooth, Wireless Local Area Network (WLAN) protocols. End user device 125 may include similar devices to end user device 115. In one embodiment, end user device 115 is a STB and other end user device 125 is a DVR. Display 140 is coupled to end user devices 115, 125 via separate network or connection 120. Display 140 presents various screens having selectable options generated by end user devices 115, 125. Remote control 135 may be configured to control end user devices 115, 125 and display 140. Remote control 135 may be used to select various options presented to a user by end user devices 115, 125 on display 140.

Whenever a user browses through a content guide, e.g., an electronic program guide (EPG) of a STB or content listing of a DVR, and there is any associated voice metadata with that content listed in the content guide, the metadata may be rendered. The metadata may be played automatically or in response to a request initiated by the user. Voice metadata may be a review of the program, highlights, reminders to the user of why the content was recorded, notes to other members of the household regarding the content, etc. A simple microphone may be used for recording the personalized voice metadata. This voice metadata is associated with program information of a program or a recorded program's content information using an index file. The format for the index file may be AMR, MP2, MP3, or any other acceptable index file format.

Recordings of voice metadata made by a user are stored in a memory of end user device 115, 125. When a user views program information for a program, e.g. media content, the user may record voice metadata. This recorded voice metadata is associated with the program in an index file for the program. A user may also pre-record voice metadata and associate the pre-recorded voice metadata with the program via the index file at a later time. When user profiles are enabled, voice metadata for multiple users may be associated with a single program. In addition, voice metadata may be pre-recorded, associated with a user profile, and retrieved at a later time for association with the program.

FIG. 2 illustrates an exemplary electronic program guide (EPG) provided by a content provider, e.g. content provider 105, and shown on display 140 via end user device 115. The exemplary EPG depicts programming that occurs between the hours of 10 am and 2 pm for channels 313, 314, 315, and 316. Channel 313 shows that Program 1 will air from 10 am-11 am; Program 2 will air from 11 am-12 pm; Program 3 will air from 12 pm-1 pm, and Program 4 will air from 1 pm-2 pm. Channel 314 shows that Program 5 will air from 10 am-12 pm and Program 6 will air from 12 pm-2 pm. Channel 315 shows that Program 7 will air from 10 am-11 am; Program 8 will air from 11 am-12 pm; and Program 9 will air from 12 pm-2 pm. Channel 316 shows that Program 10 will air from 10 am-12 pm; Program 11 will air from 12 pm-1 pm; and Program 12 will air from 1 pm-2 pm. By selecting any one of the programs in the EPG, the user will be presented with a program information screen. The user may select programs in the EPG using a remote control, e.g. remote control 135.

FIG. 3 illustrates an exemplary content listing provided by a DVR, e.g. end user device 115, 125, and shown on display 140. The exemplary content listing depicts a list of content items which happen to be recorded programs. Alternate content items can include original videos, photographs, documents, and other electronic files. The listing may list, for example, title, channel (e.g. network information), and duration information. In this example, a user has recorded Program 1, Program 5, Program 6, and Program 11. By selecting any one of the recordings listed in the content listing, the user will be presented with a content information screen. The user may select content items in the content listing using a remote control, e.g. remote control 135.

FIG. 4 illustrates an exemplary content information screen 400 showing content information of a selected content item generated by end user device 115, 125 and shown on display 140. Section 405 shows information about the selected recorded program. This information may include title, date the program was first aired, channel, duration, and standardized text tags. The standardized text tags, i.e., standardized text metadata, may describe a particular genre to which a selected program belongs, e.g., horror, comedy, action, drama. Section 410 is a text program description of the plot of the selected program. Information in sections 405, 410 may be copied from an EPG. Section 415 is the section of screen 400 that contains voice metadata options and is not copied from the EPG. In this embodiment, voice metadata has not previously been added to the program information. Item 420 may be selected by a user in order to initiate the addition of voice metadata.

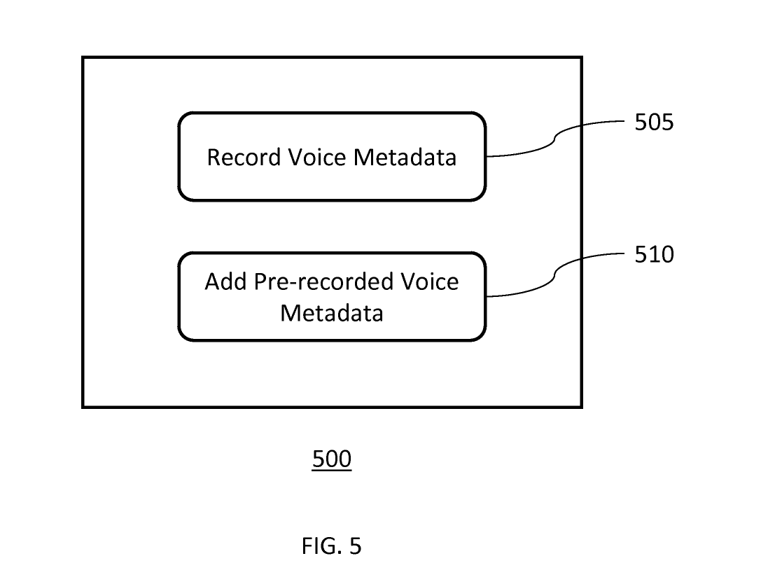

FIG. 5 illustrates an exemplary screen 500 for use in adding voice metadata. The display 140 presents screen 500 when a user selects “add voice metadata” option 420. A user may select a ‘record voice metadata’ option 505 in order to add voice metadata to program information. If a user has already recorded voice metadata and would like to add this pre-recorded voice metadata to content information, the user may select an add pre-recorded voice metadata option 510 in order to add pre-recorded voice metadata to content information. Note that item 420 in FIG. 4 may be replaced with screen 500 in order to create a more streamlined menu hierarchy.

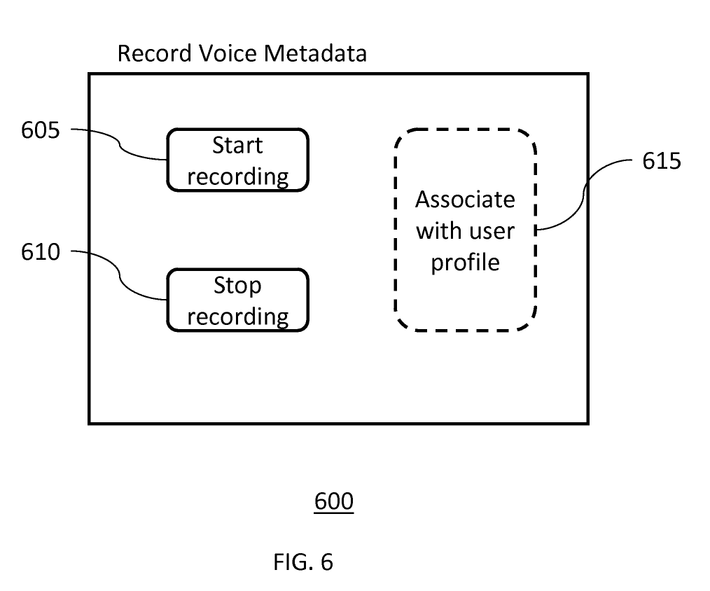

FIG. 6 illustrates an exemplary screen 600 for use in recording voice metadata. The display 140 presents screen 600 when a user selects record voice metadata option 505. From screen 600 a user may select an option to start recording 605 a spoken utterance to be used as voice metadata. After the user finishes recording, the user may select an option to stop recording 610. After the voice metadata has been recorded, the user may associate the recorded voice metadata with a user profile using option 615.

A user profile may include a user's name and links to previously-recorded voice metadata files. A user profile may be protected with a password in at least two dimensions. In a first dimension, a user profile may be view-all, or may be hidden until a password is entered into the DVR. In a second dimension, a user profile may be locked until a (second) password is entered into the DVR. Thus, each user can control who views or plays his or her voice metadata files and also separately control whether any particular voice metadata file is added to or deleted from his or her user profile.

The user profile allows a user to store the user's favorites in one place. A household may have multiple user profiles. When a user records a voice tag, the following could happen: 1) the current user profile that is loaded can be associated with the voice tag; or 2) the user is given an option to choose another profile for storing the voice tag (for example, when a child is watching a program when the currently loaded user profile is for a parent). In addition, password protection can be another option given to the user while storing the voice tag. This will enable an option to request entry of a password by a user before playing the voice tag.

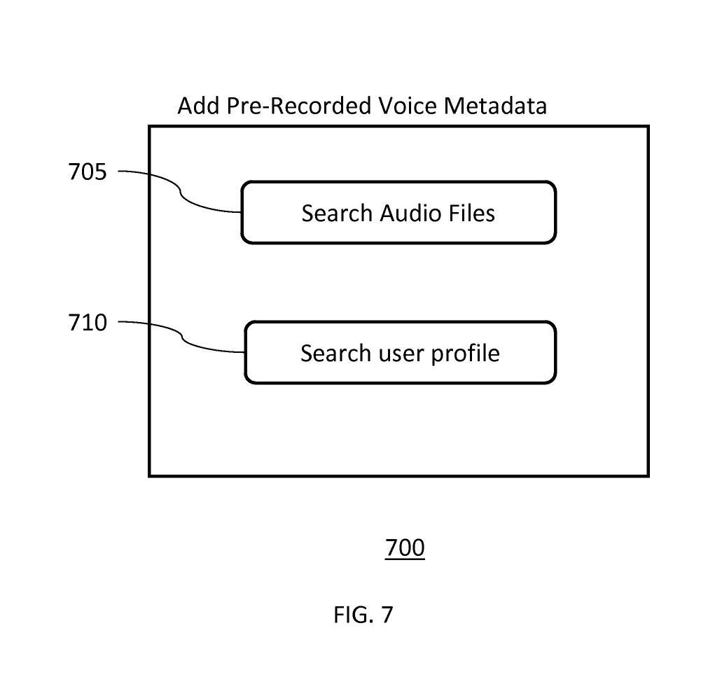

FIG. 7 illustrates an exemplary screen 700 for use in adding pre-recorded voice metadata. Display 140 presents screen 700 when a user selects ‘add pre-recorded voice metadata’ option 510. From screen 700 a user may select an option 705 to search existing audio files. If pre-recorded voice metadata has been associated with a user profile, a user may elect to search for audio files associated with the user's user profile using option 710.

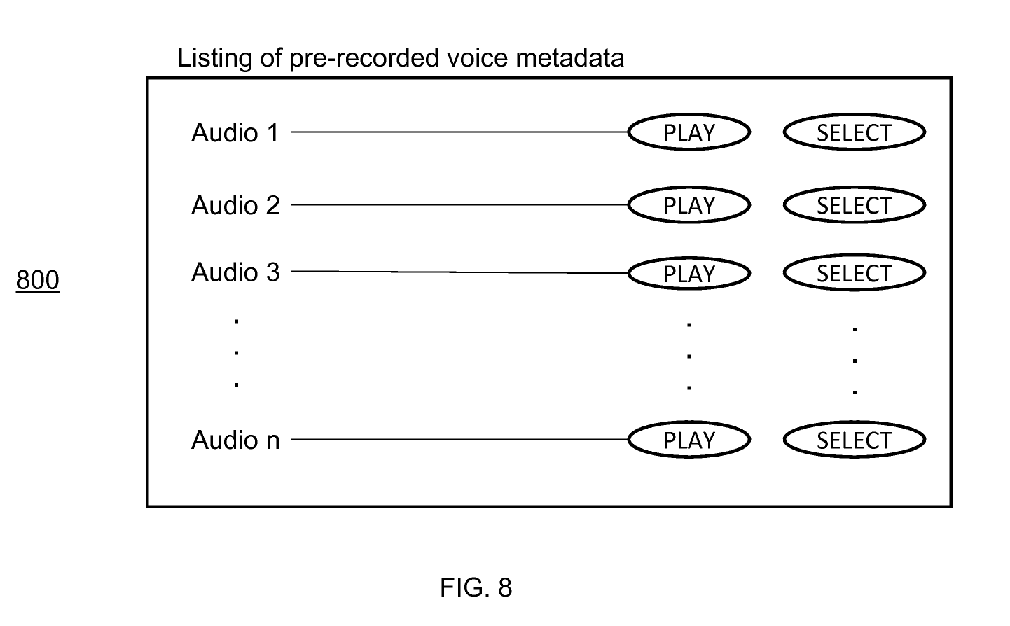

FIG. 8 illustrates an exemplary screen 800 showing a listing of pre-recorded voice metadata, according to one embodiment. Screen 800 provides a catalog of pre-recorded voice metadata (Audio 1, Audio 2, Audio 3 . . . Audio n). Although “Audio #” is shown as the label for each pre-recorded voice metadata file, more descriptive file titles can be used. Screen 800 may show all voice metadata recordings or only those voice metadata recordings associated with a particular user profile. The user may play any particular voice tag (to confirm this was the desired voice tag) and select the voice tag (to associate with the content information).

FIG. 9 illustrates an exemplary program information screen 900 showing content information of a selected content item generated by end user device 115, 125 and shown on display 140. Section 905 shows content information about a selected recorded program. This information may include title, date the program was first aired, channel, duration, and standardized text tags. The standardized text tags, i.e., standardized text metadata, may describe a particular genre that the selected program to which a selected program belongs, e.g., horror, comedy, action, drama. Section 910 is a text program description of the plot of the selected program. Information in sections 905, 910 may be copied from an EPG. Section 915 is the section of screen 900 that contains voice metadata options. In this embodiment, voice metadata has previously been added to the content information. Item 920 may be selected by a user in order to play voice metadata that has been associated with the content information. Item 925 may be selected by a user in order to edit the associated voice metadata.

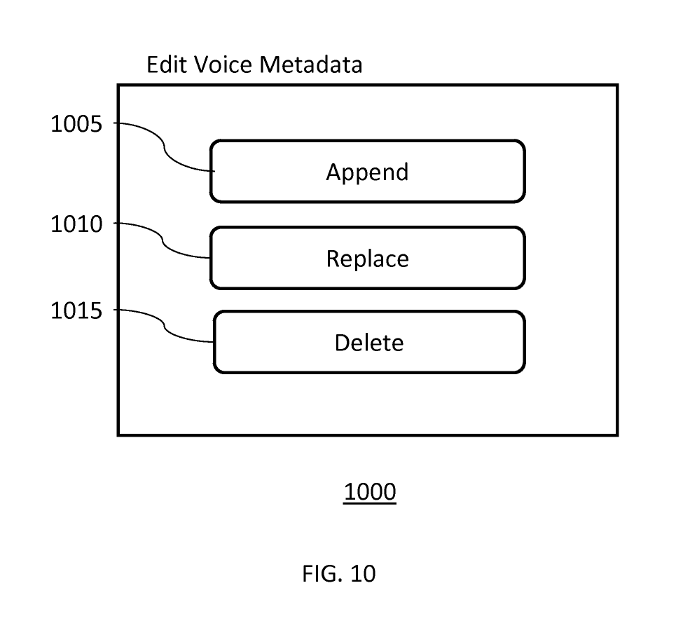

FIG. 10 illustrates an exemplary screen 1000 showing options for editing voice metadata associated with program information. The display 140 presents screen 1000 when a user selects “edit voice metadata” option 925. A user selects ‘append’ option 1005 to add additional voice metadata to an existing voice metadata recording. In this instance, a screen similar to screen 600 appears when the user selects the append option. When the user selects option 605, additional voice metadata information is recorded and appended to the existing voice metadata recording. Recording stops when the user selects option 610. Option 615 may be used to associate the resulting concatenated voice metadata with a user profile if that action has not already been performed.

A user selects ‘replace’ option 1010 to replace voice metadata currently associated with the program information. In this instance, a screen similar to screen 500 appears when the user selects the replace option. When the user selects option 505, screen 600 appears. The user selects option 605 to record new voice metadata. Recording is stopped when the user selects option 610. Option 615 may be used to associate the new (replacement) voice metadata with a user profile. Note that, during a replacement, the previous voice metadata file may be deleted as will described in more detail below.

Option 1010 may also be used to replace voice metadata with pre-recorded voice metadata. As stated above, a screen similar to screen 500 may appear when a user selects option 1010. Replacing current voice metadata with pre-recorded voice metadata may be accomplished when a user selects option 510. Display 140 presents screen 700 when a user selects ‘add pre-recorded voice metadata’ option 510. From screen 700 a user may select an option 705 to search audio files. If pre-recorded voice metadata has been associated with a user profile, a user may elect to search for audio files associated with the user's user profile using option 710 and screen 800.

A user selects option 1015 in order to delete voice metadata. In one embodiment, existing voice metadata is allowed to be deleted only by a system administrator or the authenticated user who added the tag, e.g. voice metadata. In one embodiment, the user is authenticated by entering a password that was created during creation of the voice tag.

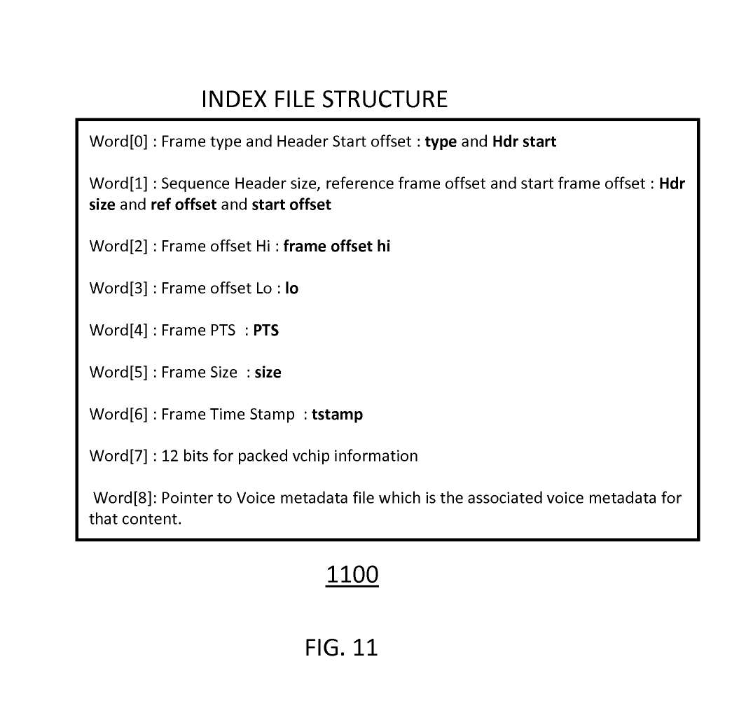

FIG. 11 illustrates an exemplary index file structure 1100. Typically, each content item has an associated index file that is used to enable trick plays (e.g., rewind, forward, pause, slow, and instant replay) and searches. This index file may be used to associate a voice recording with the content item.

Multiple users may record voice metadata for the same content item. The voice metadata recording may be tagged based on the current user profile setting. In this embodiment, Word[0] includes Frame type (type) and a Header Start offset (Hdr start). Word[1] includes a Sequence Header size (Hdr size), a reference frame offset (ref offset), and a start frame offset (start offset). Word[2] includes a Frame offset Hi (frame offset hi). Word[3] includes a Frame offset Lo (lo). Word[4] includes a Frame Presentation Time Stamp (PTS). Word[5] includes a Frame Size (size). Word[6] includes a Frame Time Stamp (tstamp). Word[7] includes 12 bits for packed vchip information. Word[8] includes a one or more pointers to one or more voice metadata files that are the associated voice metadata for the content item. Word [8] may also include one or more indications of an associated user profile when multiple user profiles have been enabled. Index files are not standardized. FIG. 11 is just one possible implementation of an index file. Generally, the index file contains time stamps (frame specific information that helps in various trick plays), pointers to metadata information like a voice tag, a pointer to content (such as a content ID), and information about the frame (I, P, or B frame; size; frame offset, etc.).

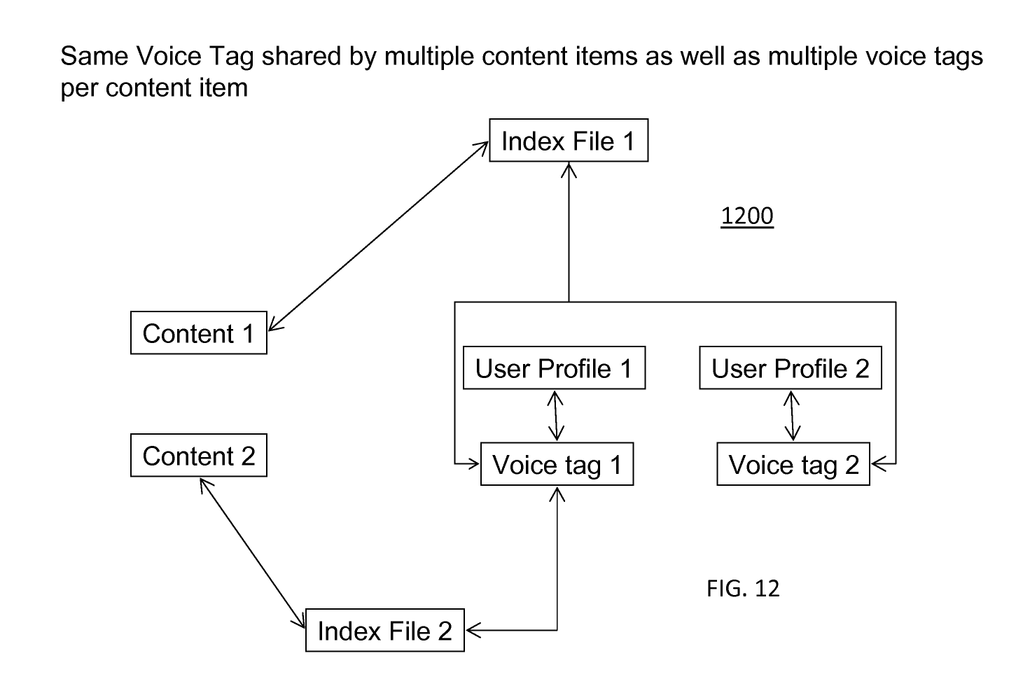

FIG. 12 illustrates a diagram 1200 describing voice tag use cases. In one embodiment, multiple voice tags may be associated with the same content item. Content 1 is associated with Index File 1. Index File 1 contains pointers to Voice tag 1 and Voice tag 2. Voice tag 1 is associated with User Profile 1. Voice tag 2 is associated with User Profile 2. As an example, User 2 may record Voice tag 2 reminding herself to re-watch the recorded program from timestamp 35:00 while User 1 may record Voice tag 1 to recommend the tagged recorded program of Content 1 to a particular friend.

In one embodiment, the same voice tag may be associated with multiple content items. Content 1 is associated with Index File 1. Index File 1 contains a pointer to Voice tag 1. Content 2 is associated with Index File 2. Index File 2 also contains a pointer to Voice tag 1. Continuing the previous example, User 1 also recommends the tagged recorded program of Content 2 to that particular friend by linking the same Voice tag 1 to the Index File 2 of Content 2.

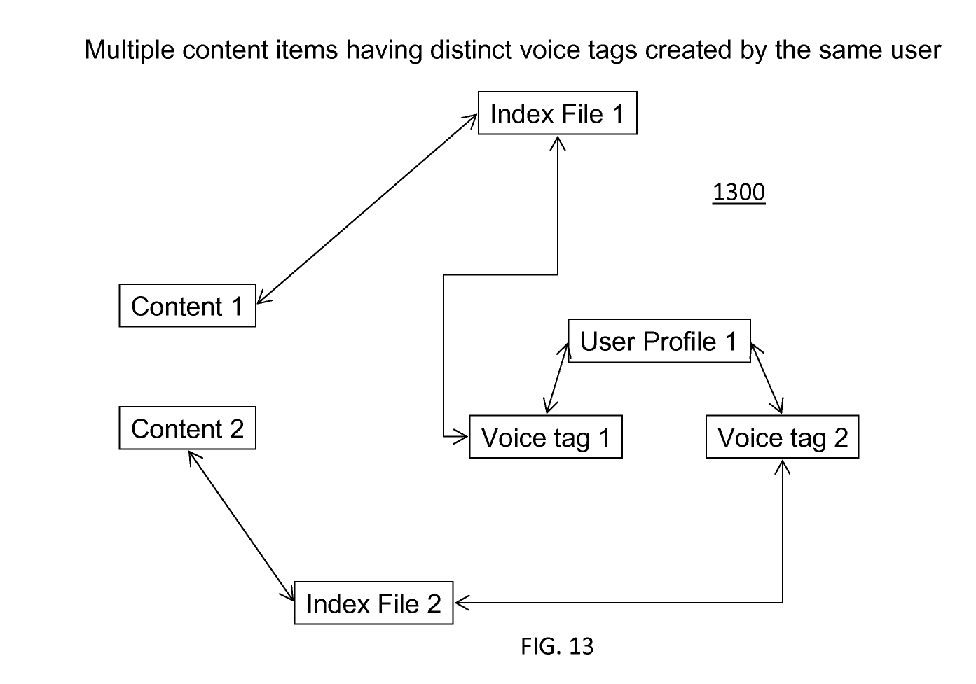

FIG. 13 illustrates a diagram 1300 describing voice tag use cases. In one embodiment, multiple content items may have distinct voice tags created by the same user. Content 1 is associated with Index File 1. Index File 1 contains a pointer to Voice tag 1. Voice tag 1 is associated with User Profile 1. Content 2 is associated with Index File 2. Index File 2 contains a pointer to Voice tag 2. Voice tag 2 is associated with User Profile 1.

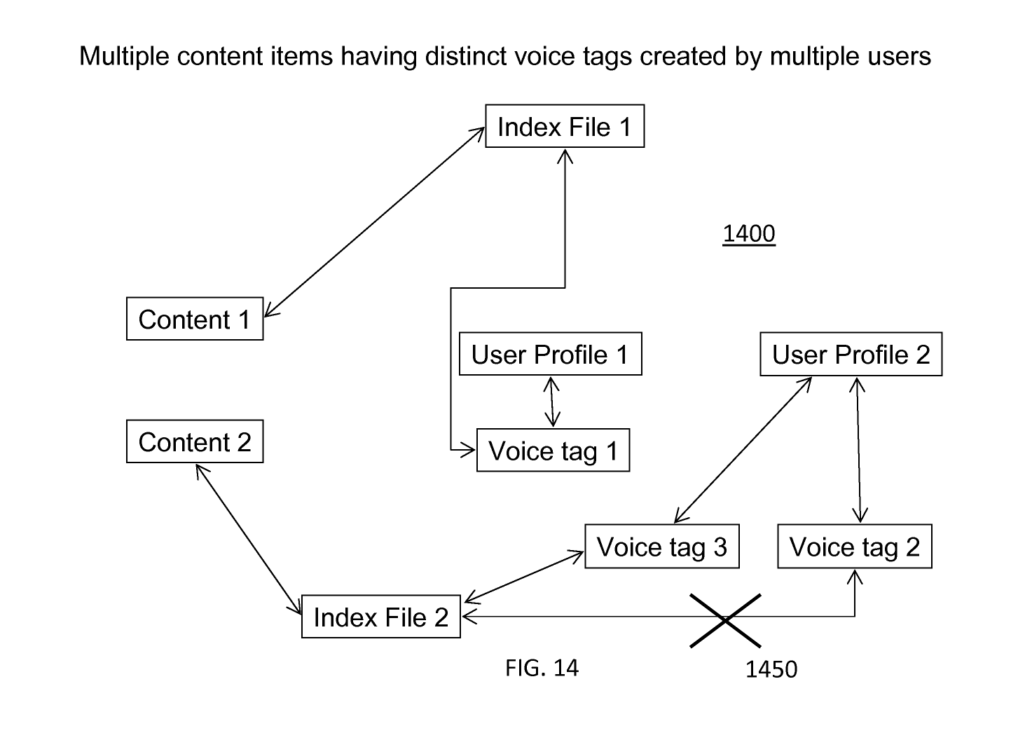

FIG. 14 illustrates a diagram 1400 describing voice tag use cases. In one embodiment, multiple content items may have distinct voice tags created by multiple users. Content 1 is associated with Index File 1. Index File 1 contains a pointer to Voice tag 1. Voice tag 1 is associated with User Profile 1. Content 2 is associated with Index File 2. Index File 2 previously had a pointer to Voice tag 2, which is associated with User Profile 2. Voice tag 2, however, was replaced by Voice tag 3. In this situation, replacing Voice tag 2 with Voice tag 3 involves a user (User Profile 2) editing existing voice metadata (see FIG. 10) using the ‘replace’ option 1010 and recording another audio clip (Voice tag 3) to replace the existing audio clip (Voice tag 2).

In summary, each content item is linked to one index file in a one-to-one relationship. An index file can be linked to any number of voice tags (including no voice tags) in a one-to-many relationship. Each voice tag can be linked to any number of user profiles (including no user profiles), and a single user profile can be linked to any number of voice tags. Each link can be two-way so that content can be linked to an index file, which can be linked to a voice tag and then to a user profile and also so that a voice query can be matched to a voice tag which in turn can lead to a user profile and/or an index file and subsequently content.

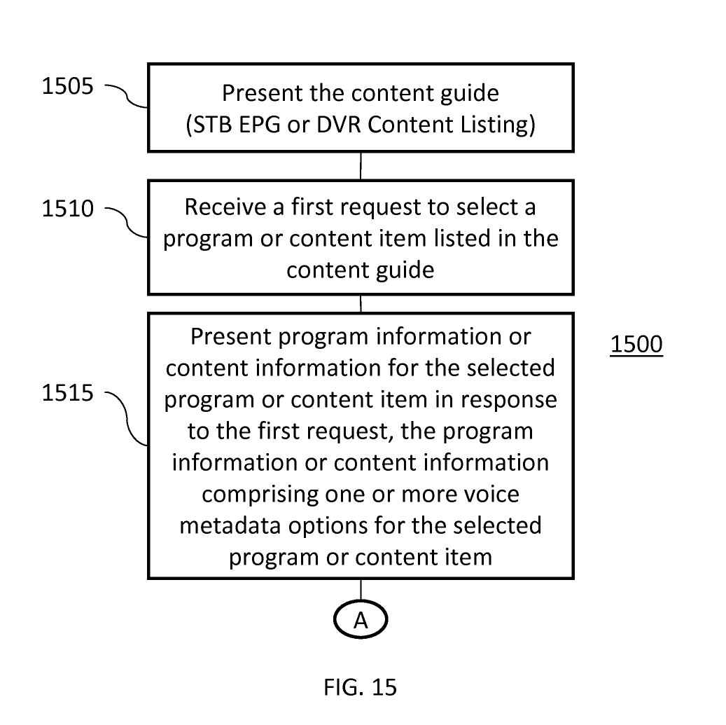

FIG. 15 illustrates a method 1500 for associating voice metadata with a content item such as a recorded program using an index file. In one embodiment, a content guide includes information from an EPG 200 provided by content provider 105 via a set top box, e.g. end user device 115. See FIG. 2. In one embodiment, the content guide is a content listing 300 of content saved on a digital video recorder, e.g. end user device 115, 125, by one or more users. See FIG. 3. At step 1505, the EPG information and/or content listing is presented by end user device 115, 125 on display 140. The EPG information and/or content listing may be presented on display 140 in response to a request initiated by a user via remote control 135. For recorded content, the stored index files and associated metadata (e.g., content metadata derived from the EPG) are linked to produce the DVR content listing.

At step 1510, the end user device receives a request to select a content item such as a recorded program listed in the content guide. At step 1515, content information, e.g., recorded program information, is presented for the selected content item in response to the request. Content information may include one or more voice metadata options for the selected content item, e.g. recorded program. See FIG. 4 and FIG. 9.

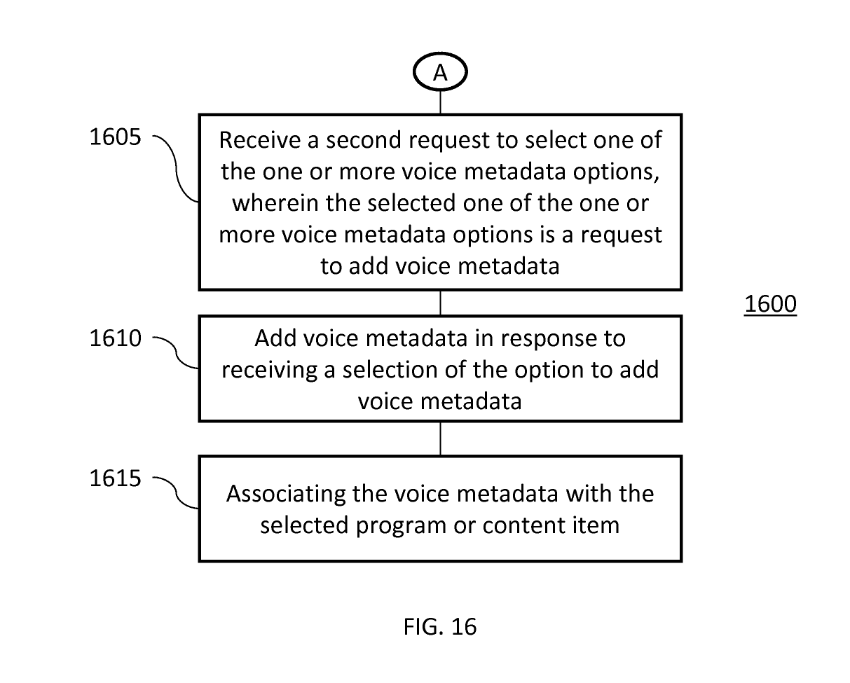

FIG. 16 illustrates a method 1600 for adding voice metadata. At step 1605, the end user device receives a request to select one of the one or more voice metadata options. In this embodiment, the selected voice metadata option is a request to add voice metadata. See FIG. 4 and FIG. 5. At step 1610, voice metadata is added in response to receiving a selection of the option to add voice metadata. In one embodiment, voice metadata is added by prompting the user to record a spoken utterance. See FIG. 6. In one embodiment, voice metadata is added by retrieving and associating pre-recorded voice metadata with the selected program information. See FIG. 7 and FIG. 8.

At step 1615, the end user device associates the added voice metadata with the selected program using an index file as shown in FIGS. 12-14. In one embodiment, the added voice metadata is also associated with a user profile through a pointer as shown in FIGS. 12-14. In one embodiment, the added voice metadata is associated with the user profile using biometric information of a user as will be described later. In one embodiment, the added voice metadata is associated with the user profile in response to a selection by a user. See FIG. 12, FIG. 13, and FIG. 14.

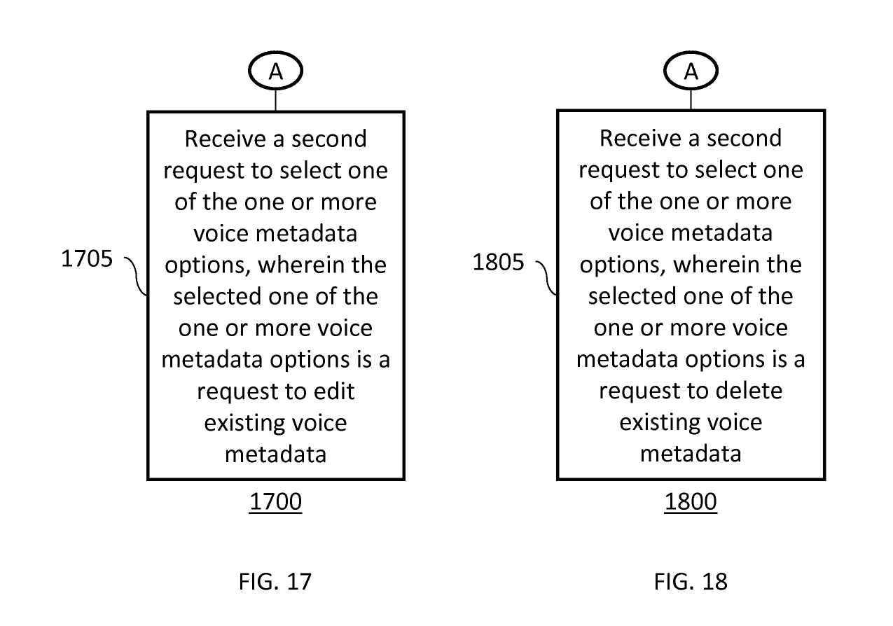

FIG. 17 illustrates a method 1700 for editing voice metadata associated with a program. At step 1705 the end user device receives a request to select one of the one or more voice metadata options. In this embodiment, the selected voice metadata option is a request to edit voice metadata. See FIG. 9. In one embodiment, existing voice metadata is edited by re-recording the voice metadata. As shown in FIGS. 10 and 14, a user selects a ‘replace’ option 1010 and records another audio clip (Voice tag 3). The end user device redirects pointer 1450 from Voice tag 2 to Voice tag 3. The Voice tag 2 may be deleted or may remain associated with the User Profile 2 as shown. In one embodiment, existing voice metadata is edited by adding additional voice metadata. See FIG. 6.

FIG. 18 illustrates a method 1800 for deleting voice metadata associated with a program. At step 1805 a request to select one of the one or more voice metadata options is received. In this embodiment, the selected voice metadata option is a request to delete voice metadata. See FIG. 10. In one embodiment, existing voice metadata is allowed to be deleted only by a system administrator or the authenticated user who added the tag, e.g. voice metadata. In one embodiment, the user is authenticated by entering a password that was created during creation of the voice tag. Deletion of a voice tag may be implemented by merely removing the pointer from the Index File to the Voice Tag. Alternately, a voice tag may be removed by deleting the Voice Tag file and both pointers to the Voice Tag file.

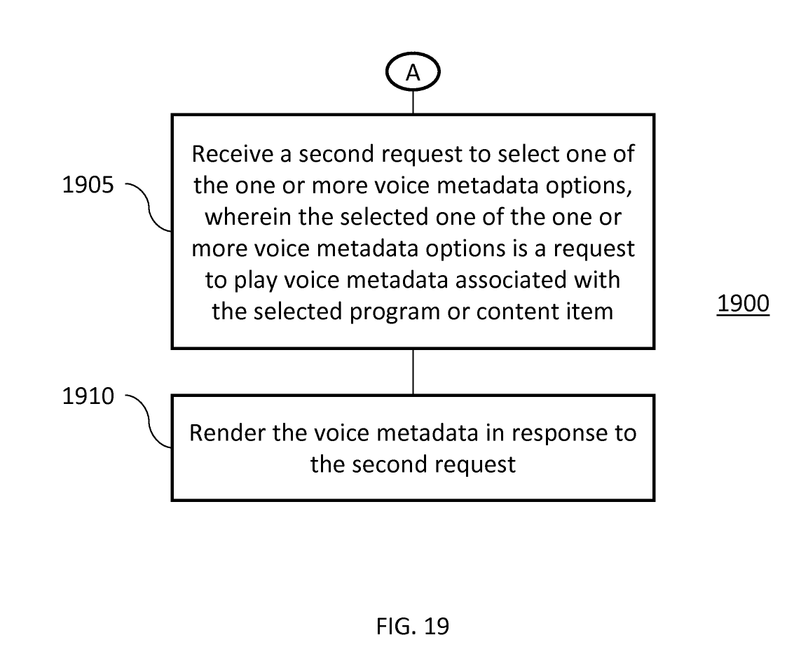

FIG. 19 illustrates a method 1900 for rendering voice metadata associated with a program. At step 1905, a request to select one of the one or more voice metadata options is received. In this embodiment, the selected voice metadata option is a request to play voice metadata associated with the selected program. At step 1910, the voice metadata is rendered in response to the request. Access to and playing of voice tags associated with a selected program may be controlled through known access/permission schemes. For example, some users (via their User Profiles) may not be able to access voice tags recorded by other users. For example, some users may not be able to “see” icons for voice tags that are marked “personal” by the creator of the voice tag. Even if access to a certain voice tag is available, some users may not be able to render that voice tag due to being marked as “private”.

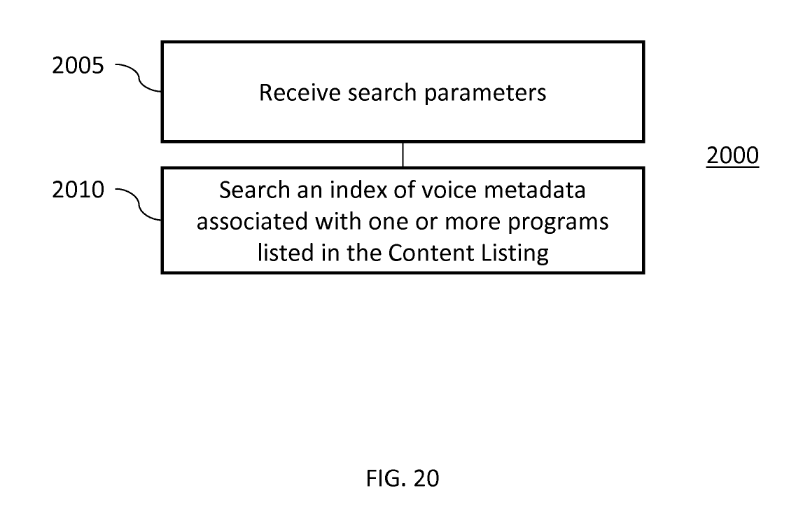

FIG. 20 illustrates a DVR content searching method 2000 according to one embodiment. At step 2005 search parameters are received. Search parameters may either be voice-based or text-based. The voice-based search parameters may be a spoken utterance of a user.

At step 2010, an index of voice metadata associated with one or more content items, e.g. recorded programs, listed in the content listing is searched, e.g. for recorded voice metadata matching the search parameters. In one embodiment, the indexed voice metadata is converted to an abstract representation in order to recognize a subsequent spoken utterance of voice metadata. The recognized metadata may be translated into Motion Picture Entertainment Group-7 (MPEG-7) descriptors. The search parameters are compared against the recorded voice tags. Any voice tag matching the search parameters is traced back to a user profile and/or an index file. Based on the access/permission settings of the user profile associated with the resulting voice tag(s), icons for the resulting voice tags may be displayed (accessed) and subsequently chosen for rendering.

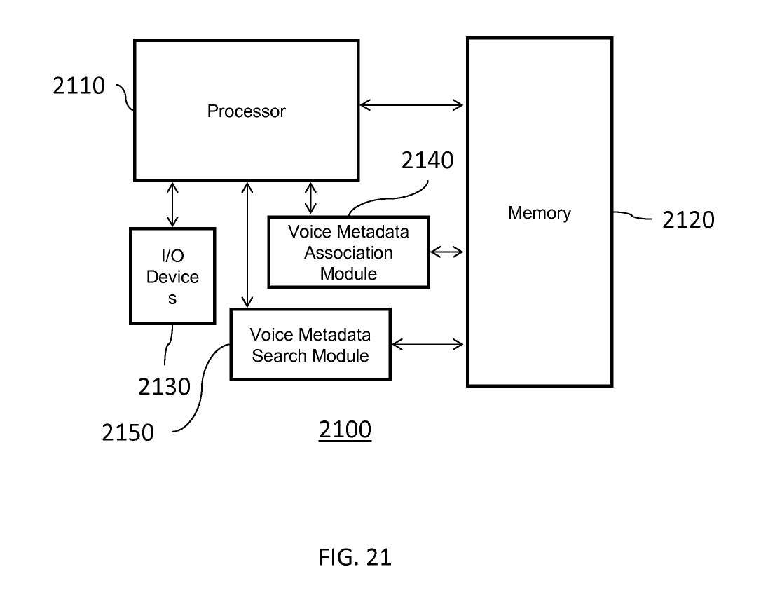

FIG. 21 illustrates a block diagram of an example device 2100. Specifically, device 2100 can be employed to associated recorded voice metadata with a program using voice metadata association module 2140. The module 2140 creates and stores the pointers in FIGS. 12-14. Also, device 2100 may be used to implement a search mechanism for searching an index of recorded voice metadata using voice metadata search module 2150. Device 2100 may be implemented in end user device 115, 125.

Device 2100 includes a processor (CPU) 2110, a memory 2120, e.g., random access memory (RAM) and/or read only memory (ROM), voice metadata association module 2140, voice metadata search module 2150, and various input/output devices 2130, (e.g., storage devices, including but not limited to, a tape drive, a floppy drive, a hard disk drive or a compact disk drive, a receiver, a transmitter, network attached storage, speaker, microphone, a display, and other devices commonly required in multimedia, e.g. content delivery, system components).

It should be understood that voice metadata association module 2140 and voice metadata search module 2150 can be implemented as one or more physical devices that are coupled to the CPU 2110 through a communication channel. Alternatively, voice metadata association module 2140 and voice metadata search module 2150 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 2120 of the computer. As such, voice metadata association module 2140 and voice metadata search module 2150 (including associated data structures) of the present invention can be stored on a computer readable medium, e.g., RAM memory, magnetic or optical drive or diskette and the like.

The processes described above, including but not limited to those presented in connection with FIGS. 4-10 and 12-20, may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium, e.g. a non-transitory computer-readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Microphone 2130 may be used to capture voice metadata when a user selects ‘start recording’ option 605. When the user selects ‘stop recording’ option 610, processor 2110 captures writes the voice metadata file to memory location 2120 (at location A). In one embodiment, processor 2110 writes the voice metadata file to an external memory location 2130 (at location A).

Module 2140 sets a pointer in a program information file (at location B) to location A in memory 2120, 2130. Module 2150 searches memory locations in memory 2120 or external memory 2130 to find the voice metadata file for rendering, modification, or deletion.

In one embodiment, microphone 2130 is used to capture biometric information in order to authenticate a user and access the user profile of the authenticated user. Using known biometric voice recognition and authentication methods, microphone 2130 may be used to capture a spoken utterance of a user. User identity is then verified by an appropriate biometric authentication algorithm.

Thus, the method and apparatus can be used to personalize information at an end user device. This personalized voice metadata may be accessed by the user or other household members depending on the details in the user profile. Thus, the personalized voice metadata is not accessible to everyone, but only those people who interact directly with the end user device.

While the foregoing is directed to embodiments of the present invention, other and further embodiments of the invention may be devised without departing from the basic scope thereof, and the scope thereof is determined by the claims that follow.

1. A method for associating voice metadata with a recorded content item using a content guide, comprising:
presenting the content guide listing one or more content items;
receiving a first request to select a content item listed in the content guide; and
presenting content information for the content item in response to the first request, the content information having one or more voice metadata options for the content item.

2. The method of claim 1, further comprising:
receiving a second request to select one of the one or more voice metadata options, wherein the selected one of the one or more voice metadata options is a request to add voice metadata to the content information;
adding voice metadata in response to receiving a selection of an option to add voice metadata; and
associating the voice metadata with the content item.

3. The method of claim 2, wherein associating the voice metadata with the content item comprises:
linking an index file of the content item to the voice metadata.

4. The method of claim 2, wherein the adding voice metadata comprises:
retrieving pre-recorded voice metadata.

5. The method of claim 4, wherein associating the voice metadata with the content item comprises:
linking an index file of the content item to the pre-recorded voice metadata.

6. The method of claim 2, further comprising:
associating the voice metadata with a user profile.

7. The method of claim 6, wherein the voice metadata is associated with the user profile in response to a selection by a user.

8. The method of claim 1, further comprising:
receiving a second request to select one of the one or more voice metadata options, wherein the selected one of the one or more voice metadata options is a request to edit existing voice metadata.

9. The method of claim 8, wherein editing existing voice metadata comprises:
re-recording the voice metadata.

10. The method of claim 8, wherein editing existing voice metadata comprises:
adding additional voice metadata.

11. The method of claim 1, further comprising:
receiving a second request to select one of the one or more voice metadata options, wherein the selected one of the one or more voice metadata options is a request to delete existing voice metadata.

12. The method of claim 11, wherein deleting existing voice metadata is allowed only by a system administrator or an authenticated user who added the voice metadata.

13. The method of claim 1, wherein the content guide comprises:
a listing of local content saved on a digital video recorder by one or more users.

14. The method of claim 1, wherein the content guide comprises:
information from an electronic programming guide provided by a content provider via a set top box.

15. The method of claim 1, further comprising:
receiving a second request to select one of the one or more voice metadata options, wherein the selected one of the one or more voice metadata options is a request to play voice metadata associated with the content item;
rendering the voice metadata in response to the second request.

16. A digital video recorder (DVR) content searching method, comprising:
receiving search parameters;
searching an index of voice metadata associated with one or more content items listed in the DVR.

17. The DVR of claim 16, wherein the search parameters are voice-based.

18. The DVR of claim 17, wherein the search parameters comprise:
a spoken utterance.

19. The DVR of claim 16, wherein the voice metadata is converted to an abstract representation in order to recognize a subsequent spoken utterance of voice metadata.

20. An apparatus for associating voice metadata with a content item using a content guide, comprising:
a processor for presenting the content guide listing one or more content items;
a receiver for receiving a first request to select the content item listed in the content guide; and
the processor presenting content information for the content item in response to the first request, the content information comprising one or more voice metadata options for the content item.
